(19) United States
(12) Patent Application Publication
(10) Pub. No.: US 2024/0049654 A1
(43) Pub. Date: Feb. 15, 2024

(54) PLANT CULTIVATION APPARATUS

(71) Applicant: LG ELECTRONICS INC., Seoul (KR)

(72) Inventor: Dongjin LEE, Seoul (KR)

(21) Appl. No.: 18/270,745

(22) PCT Filed: Dec. 22, 2021
(86) PCT No.: PCT/KR2021/019591

§ 371 Date: Jul. 3, 2023

(30) Foreign Application Priority Data
Jan. 4, 2021 (KR) 10-2021-0000414

(51) Int. Cl. A01G 9/24

(52) U.S. Cl. CPC A01G 9/249

(57) ABSTRACT

A plant cultivation apparatus is provided. The plant cultivation apparatus may include a cabinet, a bed, and a light emitting portion. A cultivation portion, which is provided inside of the cabinet and in which at least a portion of a plant is embedded, rests on the bed. The light emitting portion is provided inside of the cabinet d emits light toward the cultivation portion. The light emitting portion includes a light emitting body that emits light toward cultivation portion, and a lens located between the light emitting body and the cultivation portion. Light provided from the light emitting body is provided to the cultivation portion by being transmitted through the lens. The lens includes a first lens through which the light from the light emitting body is transmitted so as to have a first radiation angle, and a second lens through which the light from the light emitting body is transmitted so as to have a second radiation angle, which is less than the first radiation angle. The lens is configured such that the light provided from the light emitting body is selectively transmitted through either the first lens or the second lens.

### CROSS-REFERENCE TO RELATED PATENT APPLICATIONS

This application is a U.S. National Stage Application under 35 U.S.C. § 371 of PCT Application No. PCT/KR2021/019591, filed Dec. 22, 2021, which claims priority to Korean Patent Application No. 10-2021-0000414, filed Jan. 4, 2021, whose entire disclosures are hereby incorporated by reference.

### TECHNICAL FIELD

A plant cultivation apparatus, and a plant cultivation apparatus including a light emitting portion that adjusts a radiation angle of light provided to a cultivation portion is disclosed herein.

### BACKGROUND ART

A plant cultivation apparatus refers to an apparatus that enables plant cultivation by artificially supplying light energy, moisture, soil, and temperature required for plant growth. A general plant cultivation apparatus forms a predetermined cultivation space having an environment suitable for plant growth, and cultivates and stores plants in the predetermined cultivation space.

The plant cultivation apparatus is provided with a configuration for supplying moisture and nutrients required for plant growth. In addition, the plant cultivation apparatus may be provided with a configuration for artificially supplying light energy, so that plants may be cultivated in the plant cultivation apparatus without being provided with light irradiated by the sun. As a result, the plant cultivated in the plant cultivation apparatus receives nutrients, moisture, and light energy supplied from the plant cultivation apparatus and grows without the user periodically supplying moisture or nutrients during the plant cultivation.

Plants grow by receiving energy through photosynthesis, a chemical process that uses light to store energy in the form of compounds. Therefore, light, that is, light energy is an essential factor for plant growth.

As the plant cultivation apparatus artificially supplies moisture and nutrients, and adjusts the internal temperature according to a growth period of plants to be cultivated therein, it may be difficult for the plants inside to be exposed to the sun. Therefore, the plant cultivation apparatus has an artificial light energy source therein and supplies light energy to the plants inside.

As the light energy supplied to the plants inside is converted from electrical energy supplied to the plant cultivation apparatus, it is advantageous to efficiently supply the light energy inside to a region where the plants are located. In addition, a plurality of pods in which plants are cultivated may be provided in the plant cultivation apparatus, and a plurality of plants may be cultivated in one of the plurality of pods.

As a plurality of plants may have different growth rates individually, there arises a problem in that harvesting times are different even if the plants started to be cultivated at the same time. In addition, as the types of plants cultivated for each of a plurality of pods may be different, even if the cultivation process starts at the same time, when grown under the same amount of light, the harvesting time may be different, causing inconvenience to the user. Therefore, it is an important task in the art to design a plant cultivation apparatus equipped with a light energy source that artificially adjusts a growth rate of plants according to the growth rates of plants or the types of plants.

### DISCLOSURE

### Technical Problem

Embodiments disclosed herein provide a plant cultivation apparatus that adjusts an amount of light provided to plants according to a type and growth stage of the plant.

Further, embodiments disclosed herein provide a plant cultivation apparatus capable of adjusting the growth rate of plants by adjusting a required amount of light.

Furthermore, embodiments disclosed herein provide a plant cultivation apparatus capable of determining a harvest time of plants by adjusting the growth rate of plants.

In addition, embodiments disclosed herein provide a plant cultivation apparatus capable of increasing power efficiency by independently adjusting the amount of light for each of a plurality of pods.

Also, embodiments disclosed herein provide a plant cultivation apparatus capable of cultivating various plants by independently adjusting the amount of light for each of a plurality of pods.

### Technical Solution

Embodiments disclosed herein provide a plant cultivation apparatus including a plurality of lenses having different radiation angles from each other in order to solve the above problems. More specifically, the plant cultivation apparatus according to an embodiment includes a cabinet, a bed, and a light emitting portion. The bed is provided inside of the cabinet, and a cultivation portion (area) in which at least a portion of a plant is embedded is seated.

The light emitting portion is provided inside of the cabinet and irradiates light toward the cultivation portion. The light emitting portion includes a light emitting body and a lens portion (lens). More specifically, the light emitting body irradiates light toward the cultivation portion, and the lens portion is disposed between the light emitting body and the cultivation portion so that the light provided from the light emitting body is transmitted and provided to the cultivation portion.

The lens portion includes a first lens and a second lens. More specifically, the first lens is provided to transmit light from the light emitting body to have a first radiation angle, and the second lens transmits light from the light emitting body to have a second radiation angle smaller than the first radiation angle. The lens portion is provided so that the light provided from the light emitting body selectively transmits any one of the first lens or the second lens.

In the plant cultivation apparatus according to an embodiment, the light emitting body may include a first light emitting body and a second light emitting body. The first light emitting body may be disposed to face the first lens to radiate light to the first lens, and the second light emitting body may be disposed to face the second lens to irradiate light to the second lens.

The light emitting portion may be provided so that any one of the first light emitting body or the second light emitting body emits light. The light is irradiated from one of the first lens or the second lens to the cultivation portion.

The plant cultivation apparatus according to an embodiment may include a controller that controls the light emitting portion so that light is irradiated to the cultivation portion through any one of the first lens or the second lens, thereby adjusting an optical density of light provided to the cultivation portion. The light emitting portion may include a light emitting fixing portion and a lens coupling portion. More specifically, the light emitting fixing portion may be provided inside of the cabinet, and thus, the light emitting body may be fixed.

The lens coupling portion may be coupled to the light emitting fixing portion, and may be disposed between the cultivation portion and the light emitting body to provide the first lens and the second lens.

The light emitting portion may include a light emitting extension portion that extends from the lens coupling portion toward the light emitting fixing portion. The light emitting extension portion may be provided such that an inner circumferential surface facing the light emitting body reflects light irradiated from the light emitting body and concentrates the light on the lens portion. Furthermore, the light emitting extension portion may be inserted into the light emitting fixing portion and provided to be movable, and the lens coupling portion may be provided to be movable along the light emitting extension portion, and any one of the first lens or the second lens may be provided to face the light emitting body.

The plant cultivation apparatus according to an embodiment may include a driving portion (drive) and a rotational portion. More specifically, the driving portion may be provided in the cabinet to provide power to move the light emitting extension portion and the lens coupling portion.

The rotational portion may be provided to move the light emitting extension portion and the lens coupling portion by being coupled with the driving portion and being rotated. In addition, positions of the light emitting extension portion and the lens coupling portion may be changed according to a rotational angle of the rotational portion.

In addition, the plant cultivation apparatus according to an embodiment may include a rotational protrusion, more specifically, the rotational protrusion may protrude from the rotational portion. A plurality of rotational protrusions may be provided, spaced apart along a circumference of the rotational portion, and may be provided to press the light emitting extension portion. The light emitting extension portion may be selectively pressed and moved by the rotational protrusion according to a rotational angle of the rotational portion.

The plant cultivation apparatus according to an embodiment may include an elastic member provided inside of the cabinet and pressing the light emitting extension portion toward the rotational portion. When the light emitting extension portion is pressed by the rotational protrusion according to the rotational angle of the rotational portion, it can be moved toward the elastic member so that the elastic member may be elastically deformed. When the light emitting extension portion is spaced apart from the rotational protrusion according to the rotational angle of the rotational portion, it may be moved toward the rotational portion by elastic restoration of the elastic member. A plurality of light emitting portions may be provided and may be spaced apart from each other in the first direction.

The plant cultivation apparatus according to an embodiment may include an extension rod connected to the plurality of light emitting portions, extending in the first direction, and coupled to the driving portion to rotate. The rotational portion may be provided in a number corresponding to the light emitting portion, coupled to the extension rod and rotated together. The plurality of rotational portions may include a first rotational portion and a second rotational portion. In addition, the plurality of light emitting extension portions may include a first light emitting extension portion pressed by the first rotational portion and a second light emitting extension portion pressed by the second rotational portion.

The first rotational portion may be provided so that any one of the plurality of rotation protrusions presses the first light emitting extension portion at a first rotational angle. The second rotational portion may be provided such that any one of the plurality of rotation protrusions is spaced apart from the second light emitting extension portion at the first rotational angle.

The first rotational portion and the second rotational portion may be provided so that another one of the plurality of rotation protrusions presses the first light emitting extension portion or the second light emitting extension portion at a second rotational angle, respectively. In addition, the first rotational portion and the second rotational portion may be provided so that the plurality of rotation protrusions is spaced apart from the first light emitting extension portion and the second light emitting extension portion at a third rotation angle.

A plurality of cultivation portions and a plurality of light emitting portions may be provided. The light emitting portions may be disposed at a position facing the cultivation portion, respectively.

The plant cultivation apparatus according to an embodiment may include a controller provided in the cabinet and provided to control the plurality of light emitting portions. The controller may control a plurality of light emitting portions to provide light through the first lens by the plurality of light emitting portions in a basic mode, to provide light through the first lens by some of the plurality of light emitting portions in a focused mode, and to provide light through the second lens by the rest of the plurality of light emitting portions. In addition, the controller may control the plurality of light emitting portions so that the plurality of light emitting portions provides light through the second lens in an adjustment mode, but an light amount of the plurality of light emitting bodies is respectively adjusted.

The cultivation portion may include a first cultivation portion, and a second cultivation portion provided spaced apart from the first cultivation portion. The light emitting portion may include a first light emitting portion disposed at a position facing the first cultivation portion and a second light emitting portion disposed at a position facing the second cultivation portion.

The controller may control the light emitting portion in a concentration mode so that the first light emitting portion provides light to the first cultivation portion and the second cultivation portion through the first lens, and the second light emitting portion provides light to the second cultivation portion through the second lens, and thus, the amount of light irradiated to the second cultivation portion is increased compared to the first cultivation portion.

Each feature of the above-described embodiments may be implemented in combination in other embodiments unless inconsistent with or exclusive of the other embodiments.

### Advantageous Effect

Embodiments disclosed herein may provide a plant cultivation apparatus that adjusts an amount of light provided to a plant according to a type and growth stage of the plant.

Embodiments disclosed herein may further provide a plant cultivation apparatus capable of adjusting a growth rate of plants by adjusting a required amount of light.

Embodiments disclosed herein may furthermore provide a plant cultivation apparatus capable of determining a harvesting time of plants by controlling the growth rate of plants.

In addition, embodiments disclosed herein may provide a plant cultivation apparatus capable of increasing power efficiency by independently adjusting the amount of light for each of a plurality of pods.

Also, embodiments disclosed herein may provide a plant cultivation apparatus capable of cultivating various plants by independently adjusting the amount of light for each of a plurality of pods.

Effects of the embodiments are not limited to those described above, and other effects not mentioned will be clearly recognized by those skilled in the art from the description hereinafter.

### DESCRIPTION OF DRAWINGS

FIG. 1 is a perspective view illustrating a plant cultivation apparatus according to an embodiment;

FIG. 2 is a perspective view illustrating a state in which a door of the plant cultivation apparatus according to an embodiment is open;

FIG. 3 is a perspective view illustrating a state in which a light emitting portion is provided in a plant cultivation apparatus according to an embodiment;

FIGS. 4A-4C illustrate perspective views and a bottom view, respectively, illustrating a light emitting portion in the plant cultivation apparatus according to an embodiment;

FIGS. 5A-5B are side views illustrating a light emitting body and a lens portion in a plant cultivation apparatus according to an embodiment;

FIG. 6 is a perspective view illustrating a state in which a rotational portion and a light emitting portion are combined in a plant cultivation apparatus according to an embodiment;

FIG. 7 is a bottom view illustrating a rotational portion and a light emitting portion in a plant cultivation apparatus according to an embodiment;

FIG. 8 illustrates a side view illustrating a rotational portion and a light emitting portion in a plant cultivation apparatus according to an embodiment;

FIGS. 9A-9C are perspective views illustrating a rotational portion and a light emitting portion in a plant cultivation apparatus according to an embodiment;

FIGS. 10A-10C are views illustrating a relationship between a light emitting body and a lens portion according to a rotational angle of a rotational portion in a plant cultivation apparatus according to an embodiment;

FIGS. 11A-11C are views illustrating various embodiments of a light emitting portion and a lens portion controlled by a controller in a plant cultivation apparatus according to an embodiment;

FIGS. 12A-12C are views illustrating an embodiment of a concentration mode in which the amount of light is controlled to be adjusted according to overlapping of light irradiated by a plurality of light emitting body in the plant cultivation apparatus according to an embodiment; and

FIG. 13 is a diagram illustrating various control operations performed and determined by a controller in a plant cultivation apparatus according to an embodiment.

### BEST MODE

Hereinafter, embodiments disclosed in this specification will be described with reference to the accompanying drawings. In this specification, the same or similar reference numerals are given to the same or similar components even in different embodiments, and the description is replaced with the first description. Singular expressions used herein include plural expressions unless the context clearly dictates otherwise. In addition, in describing the embodiments disclosed in this specification, if it is determined that description of related known technologies may obscure the subject matter of the embodiment disclosed in this specification, the description thereof will be omitted. In addition, it should be noted that the accompanying drawings are only for easy understanding of the embodiments disclosed in this specification, and should not be construed as limiting the technical idea disclosed in this specification by the accompanying drawings.

In addition, terms to be described hereinafter are terms defined in consideration of functions, which may vary according to the intention or custom of a user or operator. Therefore, the definition should be made based on the contents throughout this specification. Terminology used in the description is only for describing the embodiments and should in no way be limiting. In this description, expressions such as “comprising” or “providing” are intended to indicate any characteristic, number, step, operation, element, portion or combination thereof, and it should not be interpreted to exclude the existence or possibility of one or more other characteristics, numbers, steps, operations, elements, portions or combinations thereof other than those described.

In addition, in describing the components of the embodiments, terms such as first, second, A, B, (a), and (b) may be used. These terms are only used to distinguish the component from other components, and the nature, sequence, or order of the corresponding component is not limited by the term.

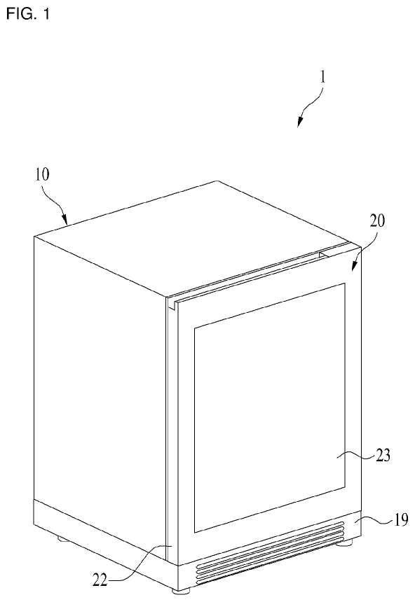

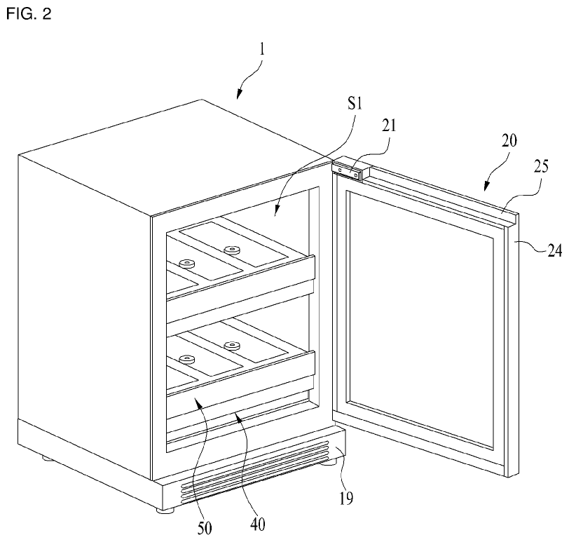

FIG. 1 is a perspective view illustrating a plant cultivation apparatus according to an embodiment. FIG. 2 is a perspective view illustrating a state in which a door is open in the plant cultivation apparatus according to an embodiment.

Referring to FIGS. 1 and 2, an outer appearance of plant cultivation apparatus 1 according to an embodiment may be formed by a cabinet 10 forming a cultivation space S1 in which plants are cultivated and a door 20 that opens and closes the cabinet 10. Plants, such as leaves and herbs that are capable of being normally used for wraps or salads, may be easily eater and cultivated by the user. Further, plants that do not occupy a large space may be cultivated.

The cabinet 10 may be formed such that one surface thereof is open, and the cultivation space S1 may be formed therein. As illustrated in FIGS. 1 and 2, the door 20 may be formed in a size capable of shielding an open surface of the cabinet 10. Hereinafter, for convenience of description, a direction in which the open surface faces is described as a frontward direction.

The door 20 may include a door panel portion 23 at least partially transparent. The door panel portion 23 may be formed of glass or a transparent plastic material to have a structure through which a user is capable of seeing through to the inside. According to this structure, the user may check the inside of the cultivation space S1 with the naked eye even in a state in which the door 20 is closed, so that a growth state of a plant may be checked, interior effects may be derived, and if an internal check is unnecessary, a neat outer appearance may be maintained.

In some cases, as the door panel portion 23 has a color or a colored coating, metal deposition, or film is attached thereto, the cultivation space S1 may be selectively visible or invisible.

The door 20 may include a door frame 22 forming a circumference and opening a central portion. The door panel portion 23 may be provided to shield the opening of the door frame 22.

The door 20 may include a door sealing member 24 provided on one surface of the door frame 22 facing the cabinet 10 and disposed along a circumference of the opening of the door frame 22. When the door 20 is closed, the door sealing member 24 may contact the cabinet 10 and shield the cultivation space S1. When the door 20 is closed, the door sealing member 24 may absorb an impact force applied to the cabinet 10 by the door 20, thereby improving durability and reliability of the plant cultivation apparatus 1.

The door sealing member 24 blocks a flow of air outside of the cultivation space S1 and the cabinet 10, so that a temperature and humidity of the cultivation space S1 may be maintained constant. In addition, the cabinet 10 may be insulated, and thus, the cultivation space S1 may maintain a temperature set by the user.

The door 20 may be provided with a door coupling portion 21 provided on one side of the door frame 22 and coupled with the cabinet 10. As illustrated in FIGS. 1 and 2, the door 20 may be provided on one or a first side of both sides of the door frame 22 in a lateral or leftward and rightward direction.

In addition, in the door coupling portion 24, the door 20 may be rotatably coupled to the cabinet 10 through the door coupling portion 24, the cultivation space S1 may be opened and closed by rotation of the door 20. In addition, the door 20 may be provided on the other or a second side of the door frame 22 and may include a door handle 25 for rotating the door 20.

A lower cabinet 19 may be disposed under the cabinet 10. Although not illustrated in the lower cabinet 10, an air adjustment portion (not illustrated) may be provided to introduce outdoor air and supply outdoor air to the cultivation space S1.

A plurality of beds 50 may be disposed vertically inside of the cabinet 10. In this embodiment, two upper and lower beds 50 are provided, and for convenience of description and understanding, they may be referred to as an upper bed 50 and a lower bed 50, respectively. Of course, two or more beds 50 may be further provided according to a size of the cabinet 10.

As will be described hereinafter, the bed 50 may be provided with a plurality of cultivation portions (areas) 60 containing plant seeds and nutrients necessary for cultivation and may be seated on the bed 50. The bed 50 may be referred to as a shelf or a tray.

The cultivation portion 60 may be provided in a form in which various kinds of seeds and suitable nutrients are suitably combined, and the user may select a product desired for cultivation. In addition, the bed 50 may have a structure in which the cultivation portion 60 may be seated and maintained in a seated state.

The bed 50 may be provided with a discharge flow path portion (not illustrated) through which water supplied from water supply portion 40 moves. In addition, the bed 50 may maintain an appropriate water level so as to supply moisture to the cultivation portion 60 at all times.

The plant cultivation apparatus 1 according to an embodiment may include a bed 50 provided inside of the cabinet 10, cultivation portion 60 which is seated on the bed 50, and in which a medium (not illustrated) in which at least a portion of the plant is embedded is accommodated, and water supply portion 40 provided inside of the cabinet to supply water to the bed 50. The water supply portion 40 may include a storage portion that stores nutrient solution of plants, a supply pump portion that pumps the nutrient solution to the cultivation portion 60, a flow rate sensor that measures a flow rate of the nutrient solution, and a water supply case that accommodates the storage portion, the supply pump portion, and the flow rate sensor therein. As the water supply case, the storage portion, the supply pump portion, and the flow rate sensor are not exposed to the outside, reliability of the water supply portion 40 may be improved and an outer appearance thereof may be formed neatly.

The cultivation portion 60 may be seated on the bed 50 so that the cultivation portion 60 may be separated from the bed 50, and thus, the user may accommodate the medium (not illustrated) containing the seeds of the plant from outside of the plant cultivation apparatus 1 in the cultivation portion 60, and may seat the cultivation portion 60 on the bed 50 at one side where the cabinet 10 is open.

A plurality of cultivation portions 60 may be provided on an upper portion of the bed 50. For this reason, the plurality of cultivation portions 60 may include different types of plants, so that different types of plants may be cultivated in the cultivation space S1. In other words, the cultivation portion 60 may be provided in a form in which various kinds of seeds and suitable nutrients are suitably combined, and the user may select a product desired for cultivation.

When growth of the plant is completed and harvest time comes, the cultivation portion 60 is separated from the bed 50 to easily harvest the plant in the cultivation portion 60 from the outside of the plant cultivation apparatus 1, so the user's convenience may be increased. In addition, the cultivation portion 60 may be formed in a shape extending from one side to the other, and a direction in which the cultivation portion 60 extends may be in a direction toward the door 20. As illustrated, a plurality of cultivation portions 60 may be provided, spaced apart from each other in a direction perpendicular to the extending direction, and seated on the bed 50 side by side.

In the plant cultivation apparatus 1 according to an embodiment, a controller (not illustrated) may be provided at a rear surface of the cabinet 10. The controller (not illustrated) may be located not only on the rear surface of the cabinet 10, but also in an empty space inside of the cabinet to control an entire operation of the plant cultivation apparatus 1 according to a user's input. In addition, the controller (not illustrated) may control to display a state of the plant cultivation apparatus 1, for example, on a display portion (not illustrated) and send the user a message about the plant cultivation apparatus 1 using wireless communication, such as Wi-Fi.

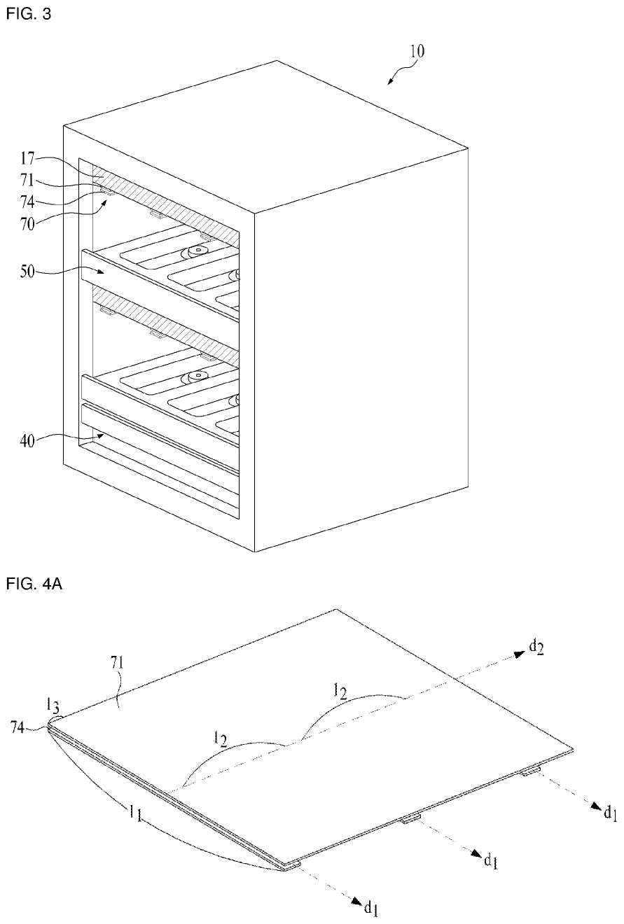

FIG. 3 is a perspective view illustrating a state in which a light emitting portion is provided in a plant cultivation apparatus according to an embodiment. The plant cultivation apparatus 1 according to an embodiment includes a light emitting portion 70 provided inside of the cabinet 10 and that irradiates light toward the cultivation portion 60. The light emitting portion 70 may be located above the bed 50. The light emitting portion 70 irradiates light toward the cultivation portion 60 seated on the bed 50 to provide light necessary for plants. An amount of light irradiated by the light emitting portion 70 may be set to be similar to sunlight, and the amount of light and irradiation time optimized for the plant to be cultivated may be set.

The light emitting portion 70 may have a disposition structure that minimizes loss of the cultivation space S1 and has high space utilization. As illustrated in FIG. 3, the bed 50 may include upper bed 50 and lower bed 50.

In addition, the light emitting portion 70 may be disposed at a position adjacent to an upper surface of the cultivation space S1 and a lower surface of the upper bed 50 disposed thereon. Both the light emitting portion 60 disposed above and the light emitting portion 60 disposed below may have a same mounting structure.

The light emitting portion 70 may be mounted on an inner surface of the cabinet 10 by a light emitting support cabinet 17 coupled to the cabinet 10. In other words, the light emitting support cabinet 17 located above the upper bed 50 and the light emitting support cabinet 17 located below the upper bed 50 may be formed in a same structure, and using the same light emitting support cabinet 17, it is possible to mount the light emitting portion 70 having the same structure in various positions inside of the cultivation space S1.

The light emitting portion 70 may include a light emitting body 72 that irradiates light toward the cultivation portion 60 and a lens portion (lens) 73 which is disposed between the light emitting body 72 and the cultivation portion 60, through which light provided from the light emitting body 72 is transmitted to be provided to the cultivation portion 60. The light emitting body 72 may be provided in various configurations capable of irradiating a light amount similar to that of sunlight and may be provided at a position corresponding to the plurality of cultivation portions 60.

In addition, the light emitting portion 70 may include a light emitting fixing portion 71 provided inside of the cabinet and coupled to the light emitting supporting cabinet 17. The light emitting body 72 is coupled to the light emitting fixing portion 71 and may be stably coupled to the cabinet 10.

The light emitting portion 70 may include a lens coupling portion 74 coupled to the light emitting fixing portion 71 and disposed between the cultivation portion 60 and the light emitting body 72 to include the lens portion 73. A plurality of lens coupling portions 74 may be provided, and may be provided to face the light emitting fixing portion 71 and the light emitting body 72 at a position corresponding to the light emitting body 72.

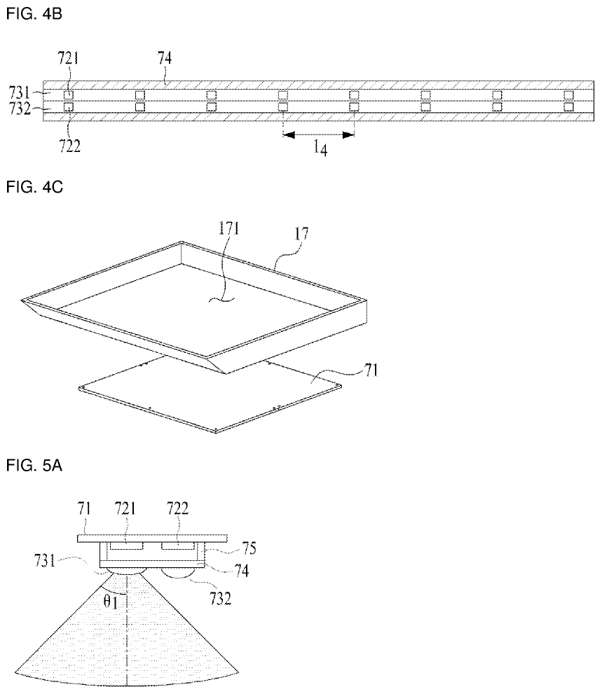

FIGS. 4A-4C illustrate perspective views and a bottom view, respectively, illustrating a light emitting portion in a plant cultivation apparatus according to an embodiment. FIG. 4A is a perspective view illustrating light emitting fixing portion 71 and lens coupling portion 74. FIG. 4B is a bottom view of the light emitting portion 70 illustrating a state in which the light emitting portion 70 is viewed from the cultivation portion 60. FIG. 4C is a perspective view illustrating a state of the light emitting fixing portion 71 and the light emitting support cabinet 17.

The cultivation portion 60 may be formed in a shape extending from one or a first side to the other or a second side. The direction in which the cultivation portion 60 extends may be a direction from the inside of the cabinet 10 toward the door 20.

A plurality of cultivation portions 60 may be provided, spaced apart from each other in a direction perpendicular to the extending direction, and seated on the bed 50 side by side. Hereinafter, for convenience of description, a direction in which the cultivation portion 60 extends is defined as a second direction d1, and a direction in which the cultivation portion 60 is disposed side by side perpendicular to the second direction d1 is defined as a first direction d2.

The light emitting fixing portion 71 may be provided in a rectangular plate shape, coupled with a plurality of lens coupling portions 74, and may extend in the first direction d2 and the second direction d1. The light emitting fixing portion 71 may extend while forming a predetermined length 11 based on the second direction d1.

The light emitting support cabinet 17 may be combined or coupled with the light emitting fixing portion 71, and a rotational portion accommodation space 171 providing a space in which a rotational portion 78, a driving portion (drive) 77, an elastic portion 76, and an extension rod 772 described hereinafter are accommodated may be formed. The lens coupling portion 74 extends in the second direction d1 and a plurality of lens coupling portions 74 may be disposed side by side in the first direction d2. The lens coupling portion 74 may extend while forming a predetermined length 11 in the second direction d1.

In addition, the lens coupling portion 74 may extend while forming a predetermined length 13 in the first direction d2. The plurality of lens coupling portions 74 may be separated by a predetermined separation distance 12 and may be disposed side by side in the first direction d2. The extension length 11 of the lens coupling portion 74 in the second direction d1 and the distance 12 spaced apart from each other may be designed appropriately according to an extension length of the cultivation portion 60 and a size of the cabinet 10, for example.

The lens portion 73 may include a first lens 731 provided to transmit light irradiated from the light emitting body 72 to the lens portion 73 to have a first radiation angle 81. In addition, the lens portion 73 may include a second lens 732 through which the light of the light emitting body 72 is transmitted to have a second radiation angle 82 smaller than the first radiation angle 81.

In addition to the first lens 731 and the second lens 732, the lens portion 73 may include a third lens and a fourth lens provided to have a gradually smaller radiation angle, but hereinafter, for convenience of description, the first lens 731 and the second lens 732 are mainly described.

At least a portion of the first lens 731 and the second lens 732 may be inserted into the lens coupling portion 74 and coupled to the lens coupling portion 74, and, in some cases, may be provided by being fixed to one side of the lens coupling portion 74. The first lens 731 and the second lens 732 may extend in the second direction d1 in which the lens coupling portion 74 extends and be provided to form a predetermined extension length 11.

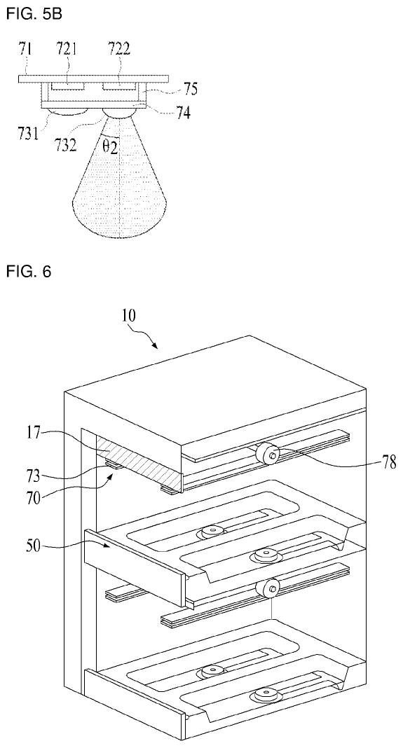

As illustrated in FIG. 4B, the first lens 731 and the second lens 732 may be provided in contact with each other, but as illustrated in FIG. 5 described hereinafter, the first lens 731 and the second lens 732 may be spaced apart from each other by a predetermined distance. This is because interference and influence between the first lens 731 and the second lens 732 may be minimized, when the first lens 731 and the second lens 732 are spaced apart from each other by a predetermined distance and light passes through the first lens 731 and the second lens 732.

The light emitting body 72 may include a first light emitting body 721 disposed to face the first lens 731 and that irradiates light to the first lens 731, and the light emitting body 72 may include a second light emitting body 722 disposed to face the second lens 732 and that irradiates light to the second lens 732.

A plurality of first light emitting bodies 721 may be provided and may be disposed to be spaced apart from each other by a predetermined distance 14 in the second direction d1 in which the first lens 731 extends. In addition, a plurality of the second light emitting bodies 722 may be provided and may be disposed to be spaced apart from each other by a predetermined distance 14 in the second direction d1 in which the second lens 732 extends.

The first light emitting body 721 and the second light emitting body 722 may be disposed to face each other in the first direction d2. Positions of the first light emitting body 721 and the second light emitting body 722 may be appropriately designed according to a position at which the plant is placed in the cultivation portion 60.

FIGS. 5A-5B are side views illustrating a light emitting body and a lens portion in a plant cultivation apparatus according to an embodiment. Hereinafter, repetitive description of like components has been omitted.

FIG. 5A is a view illustrating a state in which light is irradiated from first light emitting body 721 to first lens 731 and the light is transmitted with a first radiation angle 81. FIG. 5B is a view illustrating a state in which light is irradiated from second light emitting body 722 to second lens 732 and a light is transmitted with the second radiation angle 82.

As illustrated in FIG. 5, the light emitting portion 70 may include a light emitting extension portion 75 that extends from the lens coupling portion 74 toward the light emitting fixing portion 71. The light emitting extension portion 75 enables the lens coupling portion 74 to be disposed between the cultivation portion 60 and the light emitting body 72, and the lens coupling portion 74 may be moved as will be described hereinafter. In addition, the light emitting extension portion 75 may be provided such that an inner circumferential surface facing the light emitting body 72 reflects the light emitted from the light emitting body 72 and concentrates the light on the lens portion 73.

In other words, light emitted from the light emitting body 72 may be reflected along the light emitting extension portion 75 and concentrated on the lens portion 73. An inner circumferential surface of the light emitting extension portion 75 toward the light emitting body 72 may be further subjected to surface treatment, painting, or film attachment to improve reflection performance.

In the plant cultivation apparatus 1 according to an embodiment, the controller 90 may be provided to control the light emitting portion 70. The controller 90 may control the light emitting portion 70 to irradiate light to the cultivation portion 60 through either the first lens 731 or the second lens 732.

As the first radiation angle 81 of light passing through the first lens 731 is greater than the second radiation angle 82 of light passing through the second lens, an optical density of light passing through the first lens 731 is smaller than an optical density of light passing through the second lens based on the unit area of the cultivation portion 60. Therefore, as, in the light provided to the cultivation portion 60, the light passing through the second lens 732 has a higher optical density than the light passing through the first lens 731, it is possible to concentrate the amount of light provided to the plants provided in the cultivation portion 60.

The controller 90 may control one of the first light emitting body 721 or the second light emitting body 722 to selectively emit light, and through this, the lens portion 73 may be provided so that light provided from the light emitting body is selectively transmitted through one of the first lens 731 or the second lens 732. Through this, the amount of light per unit region of the plant of the cultivation portion 60 may be adjusted without adjusting the amount of light irradiated by the first light emitting body 721 and the second light emitting body 722.

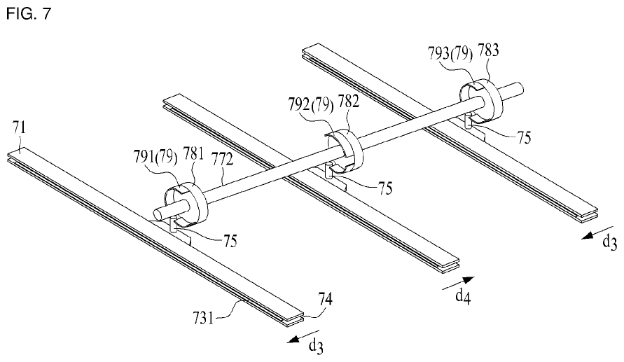

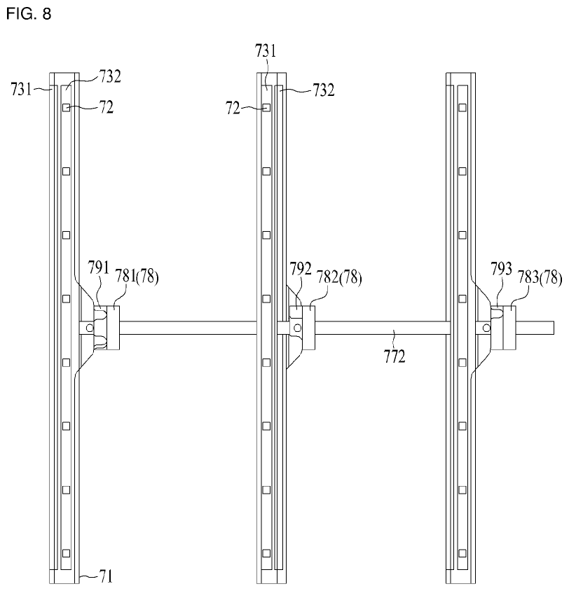

FIG. 6 is a perspective view illustrating a state in which a rotational portion and a light emitting portion is combined or coupled in a plant cultivation apparatus according to an embodiment. FIG. 7 is a bottom view illustrating a rotational portion and light emitting portion in a plant cultivation apparatus according to an embodiment. FIG. 8 illustrates a side view illustrating a rotational portion and a light emitting portion in a plant cultivation apparatus according to an embodiment. Hereinafter, repetitive description of like components has been omitted.

As the plant cultivation apparatus 1 according to an embodiment is provided in the cabinet 10, the plant cultivation apparatus 1 may include the driving portion 77 for providing power to move the light emitting extension portion 75 and the lens coupling portion 74. In addition, as the plant cultivation apparatus 1 according to an embodiment is coupled to the driving portion 77 and rotated, the plant cultivation apparatus 1 may include rotational portion 78 for moving the light emitting extension portion 75 and the lens coupling portion 74.

A plurality of light emitting portions 70 may be provided and may be spaced apart from each other in the first direction d2. In addition, the plant cultivation apparatus 1 according to an embodiment may include extension rod 772 which connects the plurality of light emitting portions 70, extends in the first direction d2, and is coupled to the driving portion 77 to rotate.

The driving portion 77, the rotational portion 78, and the extension rod 772 are provided inside of the light emitting support cabinet 17 and may be prevented from being exposed to the cultivation space S1. The number of rotational portions 78 corresponds to those of the light emitting portions 70 and may be coupled to the extension rod 772 to rotate together.

The light emitting extension portion 75 is inserted into the light emitting fixing portion 71 and provided to be movable, and the plant cultivation apparatus 1 according to an embodiment may include a plurality of rotational protrusions 79 that protrude from the rotational portion 78. The plurality of rotational protrusions 79 may be spaced apart along a circumference of the rotational portion 78 and may be provided to press the light emitting extension portion 75.

The light emitting extension portion 75 may be selectively pressed and moved by the rotational protrusion 79 according to a rotational angle P of the rotational portion 78. Due to this, positions of the light emitting extension portion 75 and the lens coupling portion 74 may be changed according to the rotational angle P of the rotational portion 78.

More specifically, as illustrated in FIG. 7, the rotational portion 78 may include a first rotational portion 781, a second rotational portion 782, and a third rotational portion 783, and the rotational protrusion 79 may include a first rotational protrusion 791 that protrudes from the first rotational portion 781, a second rotational protrusion 792 that protrudes from the second rotational portion 782, and the third rotational portion 783 that protrudes from the third rotational portion 793.

A plurality of light emitting bodies 72 may not be provided in the light emitting fixing portion 71; however, embodiments are not necessarily limited thereto.

The first rotational protrusion 791 that protrudes from the first rotational portion 781 may be provided to press the light emitting extension 75, and in this case, a position of the second lens 732 may be set to face the light emitting body 72. When the light emitting extension portion 75 is positioned between the plurality of second rotational protrusions 792, the position of the first lens 731 may be set to face the light emitting body 72.

In addition, the third rotational protrusion 793 may be provided to press the light emitting extension portion 75, and in this case, the position of the second lens 732 may be set to face the light emitting body 72. More specifically, as illustrated in FIG. 8, the first rotational protrusion 791 may be provided to press the light emitting extension portion 75, and the light emitting extension portion 75 and the lens coupling portion 74 may be moved in the third direction d3, and accordingly, the position of the second lens 732 may be set to face the light emitting body 72.

When the light emitting extension portion 75 is positioned between the plurality of second rotational protrusions 792, the light emitting extension portion 75 and the lens coupling portion 74 move in the fourth direction d4, and thus, the position of the first lens 731 may be set to face the light emitting body 72.

The third rotational protrusion 793 may be provided to press the light emitting extension portion 75, and the light emitting extension portion 75 and the lens coupling portion 74 move in the third direction d3, and thus, the position of the second lens 732 may be set to face the light emitting body 72.

The third direction d3 may be a direction in which the rotational protrusion 79 protrudes, and the third direction d3 and the fourth direction d4 may be opposite to each other. In addition, the third direction d3 and the first direction d2 may be parallel to each other.

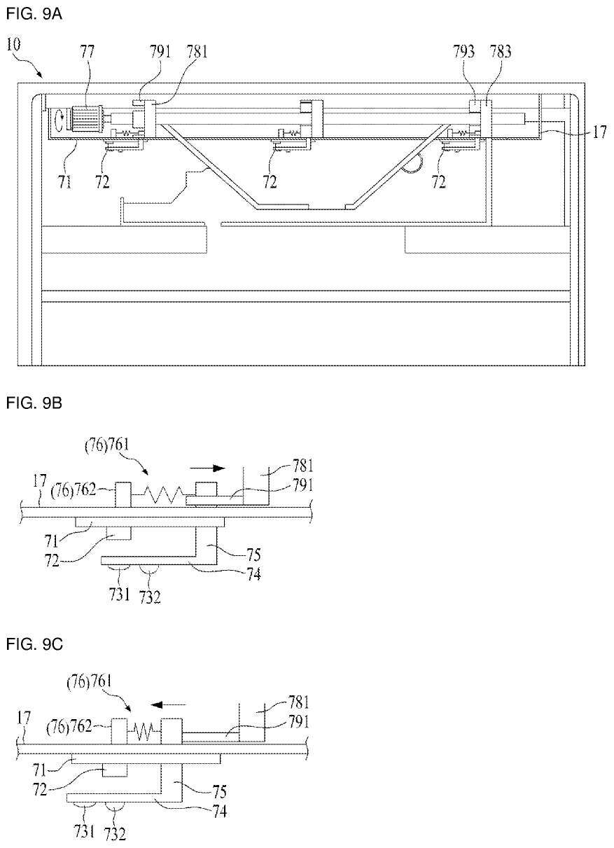

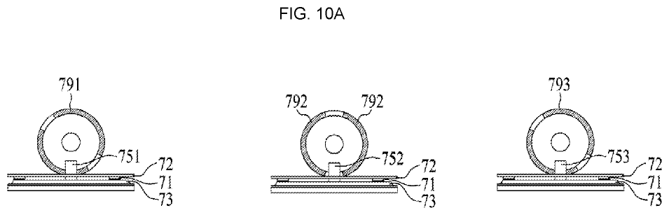

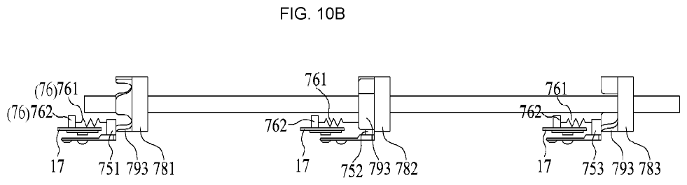

FIGS. 9A-9B illustrate a side view and an enlarged view illustrating a rotational portion and a light emitting portion in a plant cultivation apparatus according to an embodiment. FIGS. 10A-10C are views illustrating a relationship between a light emitting body and a lens portion according to a rotational angle of a rotational portion in a plant cultivation apparatus according to an embodiment. Hereinafter, repetitive description of like components has been omitted. FIG. 9A is a side view illustrating rotational portion 78 and light emitting portion 70, FIG. 9B is an enlarged view illustrating a state in which light emitting extension portion 75 is spaced apart from the plurality of first rotational protrusions 791, and FIG. 9C is an enlarged view illustrating a state in which the light emitting extension portion 75 is pressed by the first rotational protrusion 791.

The plant cultivation apparatus 1 according to an embodiment may include an elastic portion 76 provided inside of the cabinet 10 and including an elastic member 761 that presses the light emitting extension portion 75 toward the rotational portion 78. The elastic portion 76 may be provided in the rotational portion accommodation space 171 inside of the light emitting support cabinet 17. The elastic portion 76 may include an elastic support portion 762 that protrudes from one surface inside of the light emitting support cabinet 17 and an elastic member 761 combined or coupled with the elastic support portion 762 to press the light emitting extension portion 75 toward the rotational portion 78.

An extension direction of the elastic member 761, that is, a direction of elastic force may be parallel to the third direction d3 and the fourth direction d4 and may be provided parallel to the extension direction of the extension rod 772.

The light emitting extension portion 75 may extend toward the light emitting fixing portion 71 so that at least a portion thereof passes through the light emitting fixing portion 71 and may be exposed to the rotational portion accommodation space 171. In addition, the light emitting extension portion 75 may be inserted into the light emitting fixing portion 71 to be movable. Accordingly, the lens coupling portion 74 may be provided to be movable along the light emitting extension portion 75, so that either one of the first lens 731 and the second lens 732 may be provided to face the light emitting body 72.

As illustrated in FIG. 9B, when the light emitting extension portion 75 is positioned between the plurality of first rotational protrusions 791 according to the rotation of the rotational portion 78, while the elastic member 761 is elastically restored, the elastic member 761 presses the light emitting extension portion 75 toward the rotational portion 78, and the light emitting extension portion 75 and the lens coupling portion 74 move in the fourth direction d4. Thus, the position of the first lens 731 may be set to face the light emitting body 72.

As illustrated in FIG. 9C, when the first rotational protrusion 791 presses the first light emitting extension 751 toward the elastic member 761 according to the rotation of the rotational portion 78, the elastic member 761 is elastically deformed, the light emitting extension portion 75 moves toward the elastic support portion 762, and the first light emitting extension portion 751 and the lens coupling portion 74 may move toward the third direction d3. Thus, the position of the second lens 732 may be set to face the light emitting body 72.

FIG. 10A illustrates a state in which the rotational portion 78 and the light emitting portion 70 are viewed from one end of the extension rod 772. FIG. 10B illustrates side surfaces of the rotational portion 78 and the light emitting portion 70. FIG. 10C is a table illustrating a lens facing the light emitting body 72 in the first light emitting portion 70 and the second light emitting portion 70 according to the rotational angle of the rotational portion 78.

As illustrated in FIGS. 10A and 10B, the light emitting portion 70 may include first light emitting portion 70 provided to be in contact with the first rotational protrusion 791, and second light emitting portion 70 provided to be in contact with the second rotational protrusion 792, and third light emitting portion 70 provided to be in contact with the third rotational protrusion 793. At the first rotational angle P1 of the rotational portion 78, the first rotational protrusion 791 presses the first light emitting extension portion 751 toward the elastic member 761 so that the light emitting body 72 of the first light emitting portion 70 may be provided to face the second lens 732 as the first light emitting extension portion 751 is moved. In addition, when the second light emitting extension portion 752 is spaced apart from the second rotation protrusion 792 at the first rotational angle P1 of the rotational portion 78, the second light emitting portion 70 of the light emitting body 72 may be provided to face the first lens as the second light emitting extension portion 752 is moved by the elastic restoration of the elastic member 761.

At the second rotation angle P2 of the rotational portion 78, the first rotational protrusion 791 may press the first light emitting extension portion 751, and the second rotational protrusion 792 may press the second light emitting extension portion 752 so that both the light emitting bodies 72 of the first light emitting portion 70 and the second light emitting portion 70 may be provided to face the second lens 732. At the third rotational angle P3 of the rotational portion 78, the first light emitting extension portion 751 is spaced apart from the first rotational protrusion 791, and the second light emitting extension portion 752 is spaced apart from the second rotational protrusion 792 so that both the light emitting bodies 72 of the first light emitting portion 70 and the second light emitting portion 70 may be provided to face the first lens 731.

In this way, according to the rotational angle of the rotational portion 78, an operation in which the light emitting bodies 72 of the first light emitting portion 70 and the second light emitting portion 70 selectively face the first lens 731 or the second lens 732 may be independently or individually controlled. As the first light emitting portion 70 and the second light emitting portion 70 provide light toward different cultivation portions 60 in the cultivation space S1, optical densities of light provided to the different cultivation portions 60 may be adjusted.

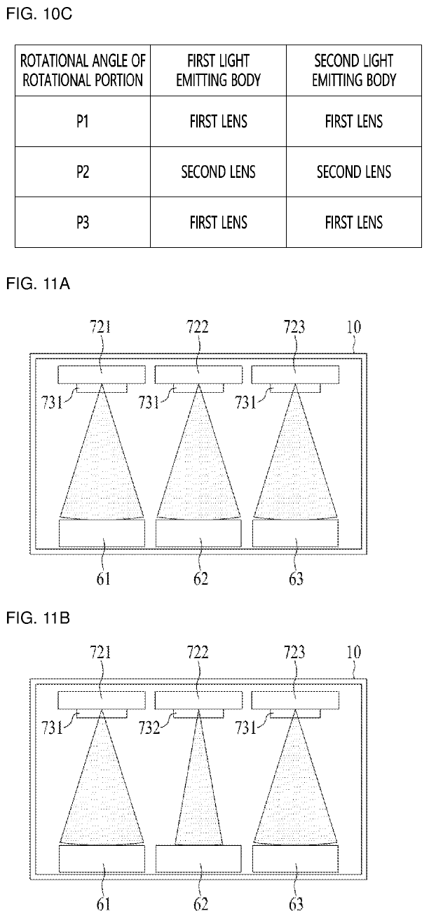

FIG. 11 is a view illustrating various embodiments of a light emitting portion and a lens portion controlled by a controller in a plant cultivation apparatus according to an embodiment. Hereinafter, it is described in a state where expressions overlapping with the above structure will be omitted.

The plurality of cultivation portions 60 may include first cultivation portion 61 facing any one of the plurality of light emitting portions 70, second cultivation portion 62 facing the other one of the plurality of light emitting portions 70, and third cultivation portion 63 facing the other one of the plurality of light emitting portions 70. As illustrated in FIG. 11A, the controller 90 may control the light emitting portion 70 or the driving portion 77 so that all of the first cultivation portion 61, the second cultivation portion 62, and the third cultivation portion 63 receive the light irradiated from the light emitting body 72 through the first lens 731. This control mode may be defined as a basic mode S500 below.

In addition, as illustrated in FIG. 11B, the controller 90 may control the light emitting portion 70 or the driving portion 77 so that the first cultivation portion 61 and the third cultivation portion 63 may receive the light irradiated from the light emitting body 72 through the first lens 731 and the second cultivation portion 62 may receive the light irradiated from the light emitting body 72 through the second lens 732. This control mode may be defined as a concentration mode S400 described hereinafter.

In addition, as illustrated in FIG. 11C, the controller 90 may control the light emitting portion 70 or the driving portion 77 so that all of first cultivation portion 61, second cultivation portion 62, and third cultivation portion 63 receive the light irradiated from the light emitting body 72 through the second lens 732, and may individually adjust the light of the light emitting body 72. This control mode may be defined as an adjustment mode S300 described hereinafter.

The developmental ecology of the plant, and the type of plant, for example, may be photographed and transmitted to the controller 90 through a photographing portion (not illustrated) provided inside of the cultivation space S1. Accordingly, the controller 90 may determine the above control mode according to a user's input, an image transmitted by the photographing portion (not illustrated), or a growth period of the plant stored in a memory (not illustrated).

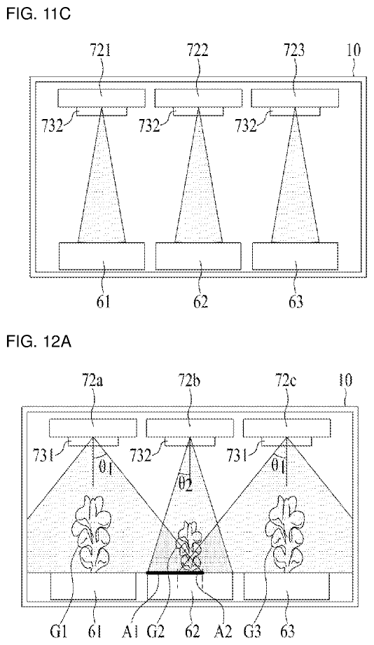

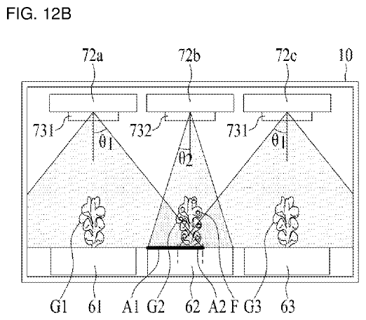

FIGS. 12A-12B are views illustrating a concentration mode in which the amount of light is controlled to be adjusted according to overlapping of light irradiated by a plurality of light emitting body in the plant cultivation apparatus according to an embodiment.

In the plant cultivation apparatus 1 according to an embodiment, the controller 90 may controls the light emitting portion 70 or the driving portion 77 so that the first cultivation portion 61 and the third cultivation portion 63 may receive the light irradiated from the light emitting body 72 through the first lens 731 and the second cultivation portion 62 may receive the light irradiated from the light emitting body 72 through the second lens 732. In addition, the cultivation portion 60 may include the first cultivation portion 61, the second cultivation portion 62 provided to be spaced apart from the first cultivation portion, and the third cultivation portion 63 provided to be spaced apart from the first cultivation portion 61 and the second cultivation portion 62. In addition, the light emitting portion 70 may include first light emitting portion 72a disposed at a position facing the first cultivation portion 61, second light emitting portion 72a disposed at a position facing the second cultivation portion 62, and third light emitting portion 72c disposed at a position facing the third cultivation portion 63.

As illustrated in FIG. 12A, the controller 90 may control to increase the amount of light irradiated to the second cultivation portion 60, when a growth size of the second plant G2 cultivated in the second cultivation portion 60 is smaller than growth sizes of the first plant G1 cultivated in the first cultivation portion 61 and the third plant G3 cultivated in the second cultivation portion 60 in the concentration mode S400.

In addition, as illustrated in FIG. 12B, the controller 90 may control to increase the amount of light irradiated to the second plant G2 to promote the growth of fruit F when the fruit F, for example, is grown in the second plant G2 cultivated in the second cultivation portion 60 in the concentration mode.

As described above, the lens portion 73 may include first lens 731 provided to transmit light irradiated from the light emitting body 72 to the lens portion 73 to have first radiation angle 81, and second lens 732 provided to transmit while having second radiation angle 82 smaller than the first radiation angle 81. In other words, unlike the concentration mode illustrated in FIGS. 11A-C, the light transmitting the first lens 731 may be provided so as to provide light to other cultivation portions, rather than to one of the plurality of cultivation portions located closest to each other.

For example, unlike illustrated in FIGS. 11A-C, the controller 90 may control the first light emitting portion 72a so that the first light emitting portion 72a provides light to the first cultivation portion 61 and the second cultivation portion 62 through the first lens 731 and may control the second light emitting portion 72b so that the second light emitting portion 72b provides light to the second cultivation portion 62 through the second lens 732. In addition, the controller may control the third light emitting portion 72c so that the third light emitting portion 72c provides light to the second cultivation portion 62 and the third cultivation portion 63 through the first lens 731.

More specifically, first region A1 of the second cultivation portion 62 may overlap the light irradiated from the first light emitting portion 72a and the second light emitting portion 72b, and second region A2 of the second cultivation portion 62 may overlap the light irradiated from the first light emitting portion 72a, the second light emitting portion 72b, and the third light emitting portion 72c. In other words, the second region A2 of the second cultivation portion 62 may be a region where the second plant G2, which is a target for concentrating the amount of light, is disposed.

As a result, the second cultivation portion 62 may be provided with a higher optical density than the first cultivation portion 61 and the third cultivation portion 63, and the controller 90 may execute the concentration mode that concentrates the amount of light of a second cultivation portion 60.

In other words, unlike an embodiment of the concentration mode S400 illustrated in FIGS. 11A-11C, the controller 90 may be provided to control the light emitting portion to adjust the amount of light according to the overlapping of the light irradiated by the plurality of light emitting bodies.

As illustrated in FIGS. 12A-12B, the controller 90 is illustrated as concentrating light only on the second cultivation portion 62, which is any one of the plurality of cultivation portions 60, in the concentration mode S400, but may control so that the light is concentrated on the plurality of cultivation portions 60 according to the number of the cultivation portion 60 and light emitting portions 70.

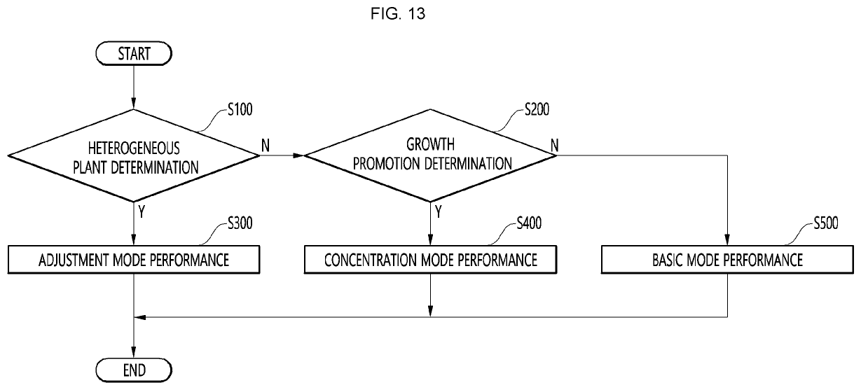

FIG. 13 is a diagram illustrating various control operations performed and determined by a controller in a plant cultivation apparatus according to an embodiment. Hereinafter, repetitive description of like components has been omitted.

As illustrated, the controller 90 may perform a heterogeneous plant determination step or operation (S100) which determines whether the types of plant cultivated in the plurality of cultivation portions 60 are heterogeneous plants, according to the image transmitted by the photographing portion (not illustrated). In addition, when the controller 90 determines that the types of plant are different for each of the plurality of cultivation portions 60 in the heterogeneous plant determination step (S100), the controller 90 may perform adjustment mode (S300).

In adjustment mode performance step or operation (S300), it is possible to adjust the amount of light appropriate for each type of plant, thereby increasing power efficiency.

If the controller 90 determines that all types of plants cultivated in the plurality of cultivation portions 60 are the same in the heterogeneous plant determination step (S100), the controller 90 may perform a growth promotion determination step or operation (S200) which determines a degree of growth of the plants cultivated in the plurality of cultivation portions 60. In the growth promotion determination step (S200), an appropriate developmental state may be determined for each plant growth period using a photographing portion (not illustrated) or a sensor (not illustrated) inside of the cabinet 10 to determine whether or not the growth of the plant is promoted.

In addition, in the growth promotion determination step (S200), when the development of plants in any one cultivation portion 60 is slow, the concentration mode (S400) may be performed. In addition, the concentration mode (S400) may be performed not only when the development is slow, but also when the plant is ready to bear fruit.

In the growth promotion determination step (S200), if all the developmental states of the plants cultivated in the plurality of cultivation portions 60 are equal to or greater than the reference value, basic mode performance step or operation (S500) may be performed.

In this way, the controller 90 may perform the adjustment mode, the concentration mode, and the basic mode. Accordingly, various crops may be cultivated in one plant cultivation apparatus 1.

Although various embodiments have been described, those skilled in the art may make various modifications to the various embodiments described above without departing from the scope. The scope should not be limited to the various embodiments described and should not be defined thereto, and should be defined by the claims to be described herein and those equivalent to the claims.

1. A plant cultivation apparatus comprising:
a cabinet;
at least one bed provided inside of the cabinet and on which at least one cultivation portion in which at least a portion of a plant is embedded is seated; and
at least one light emitting portion provided in the cabinet to irradiate light toward the at least one cultivation portion, wherein the at least one light emitting portion includes:
at least one light emitting body that irradiates light toward the at least one cultivation portion; and
at least one lens disposed between the at least one light emitting body and the at least one cultivation portion so that the light provided from the at least one light emitting body is transmitted and provided to the at least one cultivation portion wherein the at least one lens includes:
a first lens through which the light of the at least one light emitting body is transmitted with a first radiation angle; and
a second lens through which the light of the at least one light emitting body is transmitted with a second radiation angle which is smaller than the first radiation angle, and wherein the lens is configured so that the light from the light emitting body is selectively transmitted through at least one of the first lens or the second lens.

2. The plant cultivation apparatus of claim 1, wherein the at least one light emitting body includes:
a first light emitting body disposed to face the first lens and configured to irradiate light to the first lens; and
a second light emitting body disposed to face the second lens and configured to irradiate light to the second lens, and wherein at least one of the first light emitting body or the second light emitting body of the at least one light emitting portion emits light, and thus light is irradiated from at least one of the first lens or the second lens to the least one cultivation portion.

3. The plant cultivation apparatus of claim 2, further comprising:
a controller configured to adjust an optical density of light provided to the at least one cultivation portion by controlling the at least one light emitting portion so that light is irradiated to the at least one cultivation portion through the at least one of the first lens or the second lens.

4. The plant cultivation apparatus of claim 1, wherein the at least one light emitting portion includes:
a light emitting fixing portion provided inside of the cabinet and configured to fix the light emitting body in the cabinet; and
a lens coupling portion coupled to the light emitting fixing portion, disposed between the at least one cultivation portion and the at least one light emitting body, and provided with the first lens and the second lens.

5. The plant cultivation apparatus of claim 4, wherein the at least one light emitting portion further includes a light emitting extension portion that extends from the lens coupling portion toward the light emitting fixing portion, and wherein the light irradiated from the at least one light emitting body is reflected from an inner circumferential surface of the light emitting extension portion toward the at least one light emitting body and is concentrated on the at least one lens.

6. The plant cultivation apparatus of claim 5, wherein the light emitting extension portion is movably inserted into the light emitting fixing portion, and wherein the lens coupling portion is moved together with the light emitting extension portion, such that the at least one of the first lens or the second lens is provided to face the at least one light emitting body.

7. The plant cultivation apparatus of claim 6, further comprising:
a drive provided in the cabinet to provide power to move the light emitting extension portion and the lens coupling portion; and
a rotational portion that moves the light emitting extension portion and the lens coupling portion by being coupled to the drive and rotating, wherein positions of the light emitting extension portion and the lens coupling portion are changed according to a rotational angle of the rotational portion.

8. The plant cultivation apparatus of claim 7, further comprising:
a plurality of rotational protrusions that protrudes from the rotational portion, spaced apart along a circumference of the rotational portion, and provided to press the light emitting extension portion, wherein the light emitting extension portion is selectively pressed and moved by the plurality of rotational protrusions according to a rotational angle of the rotational portion.

9. The plant cultivation apparatus of claim 8, further comprising:
at least one elastic member provided in the cabinet and configured to press the light emitting extension portion toward the rotational portion, wherein the light emitting extension portion is moved toward the at least one elastic member when pressed by the plurality of protrusions, so that the at least one elastic member is elastically deformed, and moved toward the rotational portion by elastic restoration of the at least one elastic member when spaced apart from the plurality of rotational protrusions.

10. The plant cultivation apparatus of claim 9, further comprising:
an extension rod that extends in a first direction and coupled to the drive to be rotated thereby, wherein the at least one light emitting portion comprises a plurality of light emitting portions spaced apart in the first direction, and wherein the rotational portion is provided in a number corresponding to a number of the plurality of light portions and is coupled to the extension rod to rotate together with the extension rod.

11. The plant cultivation apparatus of claim 10, wherein the plurality of rotational portions includes a first rotational portion and a second rotational portion, wherein the plurality of light emitting extension portions includes a first light emitting extension portion moved by the first rotational portion and a second light emitting extension portion moved by the second rotational portion, wherein the first rotational portion is provided so that one of the plurality of rotational protrusions presses and moves the first light emitting extension portion a first rotational angle, and wherein the second rotational portion is provided so that the plurality of rotational protrusions is spaced apart from the second light emitting extension portion at the first rotational angle.

12. The plant cultivation apparatus of claim 11, wherein the first rotational portion presses and moves the first light emitting extension portion with another one of the plurality of rotational protrusions a second rotational angle, wherein the second rotational portion presses and moves the second light emitting extension portion with any one of the plurality of rotational protrusions at the second rotational angle, and wherein the first rotational portion and the second rotational portion are spaced apart from the first light emitting extension portion and the second light emitting extension portion with the plurality of rotational protrusions at a third rotational angle.

13. The plant cultivation apparatus of claim 1, wherein the at least one cultivation portion comprises a plurality of cultivation portions, wherein the at least one light emitting portion comprises a plurality of light emitting portions disposed to face the plurality of cultivation portions, respectively, wherein the plant cultivation apparatus further comprises a controller provided in the cabinet and configured to control the plurality of light emitting portions, and wherein the controller controls the plurality of light emitting portions so that the plurality of light emitting portions provide light through the first lens in a basic mode, and controls the plurality of light emitting portions so that some of the plurality of light emitting portions provide light through the first lens, and the rest of the plurality of light emitting portions provide light through the second lens in a concentration mode.

14. The plant cultivation apparatus of claim 13, wherein the controller controls the plurality of light emitting portions so that the plurality of light emitting portions provide light through the second lens in an adjustment mode, in which an amount of light of the plurality of light emitting portions is respectively adjusted.

15. The plant cultivation apparatus of claim 13, wherein the least one cultivation portion includes a first cultivation portion, and a second cultivation portion spaced apart from the first cultivation portion, wherein the plurality of light emitting portions includes a first light emitting portion disposed at a position facing the first cultivation portion and a second light emitting portion disposed at a position facing the second cultivation portion, and wherein the controller controls the plurality of light emitting portions in the concentration mode so that the first light emitting portion provides light to the first cultivation portion and the second cultivation portion through the first lens and the second light emitting portion provides light to the second cultivation portion through the second lens and thus an amount of light irradiated to the second cultivation portion is increased with respect to an amount of light irridated to the first cultivation portion.

16. A plant cultivation apparatus, comprising:
a cabinet;
at least one bed provided inside of the cabinet and on which at least one cultivation area in which at least a portion of a plant is embedded is seated; and
at least one light emitting portion provided in the cabinet to irradiate light toward the at least one cultivation area, wherein the at least one light emitting portion includes:
a plurality of light emitting bodies that irradiate light toward the at least one cultivation area;
a plurality of lenses disposed between the plurality of light emitting bodies and the at least one cultivation area so that the light provided from the plurality of light emitting bodies is transmitted and provided to the at least one cultivation area, wherein the plurality of lenses include:
a first lens through which light of a first light emitting body of the plurality of light emitting bodies is selectively transmitted with a first radiation angle; and
a second lens through which light of a second light emitting body of the plurality of light emitting bodies is selectively transmitted with a second radiation angle, which is smaller than the first radiation angle; and
a controller configured to provide selective transmission of light through at least one of the first lens or the second lens.

17. The plant cultivation apparatus of claim 16, wherein the first light emitting body is disposed to face the first lens and configured to irradiate light to the first lens, and wherein the second light emitting body disposed to face the second lens and configured to irradiate light to the second lens.

18. The plant cultivation apparatus of claim 17, wherein the controller is configured to adjust an optical density of light provided to the at least one cultivation area by controlling the at least one light emitting portion so that light is irradiated to the at least one cultivation area through the at least one of the first lens or the second lens.

19. The plant cultivation apparatus of claim 16, wherein the at least one cultivation area comprises a plurality of cultivation areas, wherein the at least one light emitting portion comprises a plurality of light emitting portions disposed to face the plurality of cultivation areas, respectively, and wherein the controller is configured to control the plurality of light emitting portions so that the plurality of light emitting portions provide light through the first lens in a basic mode, and control the plurality of light emitting portions so that some of the plurality of light emitting portions provide light through the first lens, and the rest of the plurality of light emitting portions provide light through the second lens in a concentration mode.

20. The plant cultivation apparatus of claim 19, wherein the controller is configured to control the plurality of light emitting portions so that the plurality of light emitting portions provide light through the second lens in an adjustment mode, in which an amount of light of the plurality of light emitting portions is respectively adjusted.
